(19) United States
(12) Patent Application Publication
(10) Pub. No.: US 2016/0191345 A1
(43) Pub. Date: Jun. 30, 2016

(54) SYSTEM AND METHOD FOR SERVICE EMBEDDING AND RESOURCE ORCHESTRATION

(71) Applicant: Huawei Technologies Co., Ltd., Shenzhen (CN)

(72) Inventors: Zoran Despotovic, Munich (DE); Riccardo Guerzoni, Munich (DE); Riccardo Trivisonno, Munich (DE); lshan Vaishnavi, Munich (DE)

(21) Appl. No.: 15/061,475

(22) Filed: Mar. 4, 2016

Related U.S. Application Data
(63) Continuation of application No. PCT/EP2013/068428, filed on Sep. 6, 2013.

(51) Int. Cl. H04L 12/24; G06F 17/30; H04L 29/08

(52) U.S. Cl. CPC H04L 41/5054; H04L 67/327; H04L 67/16; H04L 41/5006; G06F 17/30864

(57) ABSTRACT

The patent application relates to a system for service embedding and resource orchestration, the system comprising: a service providing entity to provide services to users; at least one physical infrastructure providing entity, configured to provide infrastructures, the infrastructures composed by physical resources which are virtualized and exposed for usage; a brokering entity interfacing the service providing entity and the physical infrastructure providing entities, wherein the brokering entity is configured to provide the service providing entity with the infrastructures from the physical infrastructure providing entities based on an optimization criterion with respect to availability, cost and technical characteristics of the infrastructures.

### CROSS-REFERENCE TO RELATED APPLICATIONS

This patent application is a continuation of International Application No. PCT/EP2013/068428, filed on Sep. 6, 2013, which is hereby incorporated by reference.

### TECHNICAL FIELD

The present disclosure relates to a system and method for service embedding and resource orchestration. The disclosure further relates to Future Carrier Network (FCN) architecture.

### BACKGROUND

Declining revenues and increasing operational costs are forcing network operators to rethink the ways they operate their networks and provide their services. Technologies such as Cloud Computing, Software Defined Networking and Network Virtualization are clearly pointing the main directions to be taken by the network operators. Wherever possible (e.g. allowed by strict performance requirements) both end user services and network functions are provided on top of common hardware and software platforms in order to reduce their operational costs. At the same time, physical resources are pooled together and sliced when and as needed in order to deliver a service, leading to their higher utilization and further OPEX (operational expenditures) reduction. Trends like this are easy to observe in the networking industry nowadays.

As shown in FIG. 1, the future business ecosystem will comprise the following four key actors: the User 101, the Service Provider (SP) 105, the FCN Broker 107, and the Physical Infrastructure Provider (PIP) 109. The main roles they play in the ecosystem are as follows. Physical infrastructure providers 109 consolidate physical resources, pool them together and expose them as service to service providers 105 or any other entity that can add value and resell them further. It is unrealistic to expect that service providers 105 will focus on both interfacing the user 101 (i.e. understand the semantics and any details of the service they deliver) and maintaining registries of PIPs 109 that list their infrastructure and its properties. This role will be taken on by another player that are called FCN broker 107. The presence of FCN broker 107 represents a strong discontinuity with respect to the current telco (telecommunications) ecosystem. Its role is to provide the service provider 105 with a tailored virtual telco infrastructure, exploiting efficiently all physical available infrastructure, regardless their location and/or ownership.

### SUMMARY

It is the object of the patent application to provide an improved Future Carrier Network (FCN) architecture.

This object is achieved by the features of the independent claims. Further implementation forms are apparent from the dependent claims, the description and the figures.

The patent application is based on a new FCN architecture involving service providers, brokers and physical infrastructure providers and details on the building blocks of the involved parties and their interaction.

The focus lies on the interaction between PIPs and an FCN broker, aspects of operation of service providers are touched as well. Aspects detail on the following issues: Defining an architecture (comprising logical functions and logical interfaces) allowing the proper interactions among key players, enabling the dynamic instantiation of virtual infrastructures required by service providers (SPs) to provide services to users; specifying a methodology, within the devised architecture, allowing: the PIPs to make the list of available physical resources (PRs) public; the Broker to interpret service requests issue by SPs, and to instantiate efficiently the required virtual infrastructure, according to combined economic and technical constraints and to the negotiated SLAs (service level agreements); the SP to operate the virtual infrastructure, while providing the service to the users; and the Broker and the PIPs to manage and monitor the virtual infrastructure, ensuring fulfillment of SLAs.

In one embodiment, also named as network function virtualization (NFV), a network operator (taking the role of a service provider in the ecosystem described in this disclosure) sends a request to a broker to find appropriate infrastructure in a multitude of data centers (possibly owned by different physical infrastructure providers) that can be used to host network functions needed to run the network of the network operator (e.g. BRAS, RNC, GGSN, SGSN, etc.). The Broker contacts its known physical infrastructure providers and negotiates the terms of infrastructure to use. The broker does it so as to split the original request from the network operator in such a way to maximize its own profits, while physical infrastructure owners optimize placement of requested functions across their infrastructure. Algorithms and communication patterns described in this disclosure can be used to realize this use case.

In order to describe the patent application in detail, the following terms, abbreviations and notations will be used:
FCN Future Carrier Network
MBB Mobile Broad Band
PIP Physical Infrastructure Provider
O&M Operation and Maintenance
SLA Service Level Agreements
NfV Network Function Virtualisation
RM Resource Manager
VM Virtual Machine
RAN Radio Access Network
RAT Radio Access Technology
VNO Virtual Network Operator
MVNO Mobile Virtual Network Operator
VNP Virtual Network Provider
EPS Evolved Packet System
IaaS Infrastructure as a Service
PR Physical Resources

According to a first aspect, the patent application relates to a system for service embedding and resource orchestration, the system comprising: a service providing entity to provide services to users; at least one physical infrastructure providing entity, configured to provide infrastructures, the infrastructures composed by physical resources which are virtualized and exposed for usage; a brokering entity interfacing the service providing entity and the physical infrastructure providing entities, wherein the brokering entity is configured to provide the service providing entity with the infrastructures from the physical infrastructure providing entities based on an optimization criterion with respect to availability, cost and technical characteristics of the infrastructures.

By configuring the brokering entity to provide the service providing entity with the infrastructures from the physical infrastructure providing entities based on an optimization criterion with respect to availability, cost and technical characteristics of the infrastructures, the system allows the proper interactions among key players and enables the dynamic instantiation of virtual infrastructures required by service providers (SPs) to provide services to users.

In a first possible implementation form of the system according to the first aspect, the brokering entity comprises a negotiating entity configured to perform one or more of the following tasks: keeping updated information on available physical infrastructure providing entities, receiving service requests from the service providing entity, negotiating and reserving resources with the physical infrastructure providing entities, managing offers for the service requests with the service providing entity, and triggering a Solution Embedding procedure towards negotiating entities of the physical infrastructure providing entities.

When the brokering entity comprises a negotiating entity configured to perform one or more of the described tasks, the brokering entity is able to dynamically provide the required services.

In a second possible implementation form of the system according to the first aspect as such or according to the first implementation form of the first aspect, the brokering entity comprises an orchestrating entity configured to perform one or more of the following tasks: splitting the service requests into sub graphs in accordance with the optimization criterion, in particular based on a partition assignment generation algorithm; and determining rearrangement and re-embedding of the service requests based on modified conditions at the physical infrastructure providing entities, in particular based on an optimization and reconfiguration algorithm.

When the brokering entity comprises an orchestrating entity configured to perform one or more of the described tasks, the brokering entity is able to dynamically follow modified service requests.

In a third possible implementation form of the system according to the first aspect as such or according to any of the previous implementation forms of the first aspect, the brokering entity comprises a resource manager configured to perform one or more of the following tasks: allowing the brokering entity (301) to access the physical resources, and maintaining and managing access information at the brokering entity and at the service providing entity.

When the brokering entity comprises a resource manager configured to perform one or more of the described tasks, the brokering entity is able to receive access information with respect to physical resources.

In a fourth possible implementation form of the system according to the first aspect as such or according to any of the previous implementation forms of the first aspect, the brokering entity comprises a database configured to collect data relating to technical characteristics and pricing information of the available physical infrastructure providing entities.

When the brokering entity comprises a database, the brokering entity is able to access and store information with respect to technical characteristics and pricing information.

In a fifth possible implementation form of the system according to the first aspect as such or according to any of the previous implementation forms of the first aspect, each of the physical infrastructure providing entities comprises a database configured to collect data relating to the physical resources controlled by the physical infrastructure providing entity.

When the PIPs comprise a database, the PIPs are able to collect data of physical resources.

In a sixth possible implementation form of the system according to the fifth implementation form of the first aspect, each of the physical infrastructure providing entities comprises a negotiating entity configured to perform one or more of the following tasks: defining pricing and publishing criteria for the physical resources relating to the physical infrastructure providing entities; updating and maintaining the database of the physical infrastructure providing entities with pricing and publishing information; managing a publication procedure towards the negotiating entity of the brokering entity; and managing the negotiation and resource reservation procedure with the negotiating entity of the brokering entity.

When the PIPs comprise a negotiating entity, the PIPs can efficiently communicate with the brokering entity.

In a seventh possible implementation form of the system according to the first aspect as such or according to any of the previous implementation forms of the first aspect, each of the physical infrastructure providing entities comprises an orchestrating entity configured to perform one or more of the following tasks: embedding the service request with respect to technical and pricing characteristics of the physical infrastructure providing entity in accordance with an optimization criterion, in particular based on an embedding algorithm; negotiating with virtualization controllers of the physical resources with regard to virtualization and exposal of the physical resources; triggering an instantiation procedure where virtual infrastructure are instantiated over physical infrastructures; and determining rearrangement and re-embedding of the service requests based on modified conditions at the physical resources, in particular based on an optimization and reconfiguration algorithm. PIPs, i.e. physical infrastructure providing entities, and brokers, i.e. brokering entities, can have different optimization criteria.

When the PIPs comprise an orchestration entity, the PIPs can efficiently perform embedding the service request with respect to technical and pricing characteristics.

In an eighth possible implementation form of the system according to the seventh implementation form of the first aspect, each of the physical infrastructure providing entities comprises a resource manager configured to perform one or more of the following tasks: handling a registration procedure for the physical resources; performing the instantiation procedure with the orchestration entity of the physical infrastructure providing entity; and mapping high level requests from one of the service providing entity and the brokering entity into low level commands specific to physical resources.

When the PIPs comprise a resource manager, the PIPs can efficiently instantiate physical resources.

In a ninth possible implementation form of the system according to the eighth implementation form of the first aspect, the system comprises: an interface between the brokering entity and the physical resources configured to access information and to monitor data transfer; an interface between the physical infrastructure providing entity and the physical resources configured to carry signaling and to discover and control the physical resources; an interface between the physical infrastructure providing entity and the brokering entity configured to carry signaling for the publication procedure, the negotiation and resource reservation procedure, the embedding the service request, the management of access information and the instantiation procedure; and an interface between the brokering entity and the a service providing entity configured to carry signaling required by the service providing entity to issue the service request, to support offer and negotiation procedure between the service providing entity and the brokering entity and to transfer required access information to the service providing entity.

When the system comprises these interfaces, communication between the different system components is improved.

According to a second aspect, the patent application relates to a method for service embedding and resource orchestration in a system comprising a service providing entity for providing services to users, a set of physical infrastructure providing entities for providing infrastructures made by physical resources and a brokering entity for providing the service providing entity with the infrastructures from the physical infrastructure providing entities, the method comprises: publishing the infrastructures and updating databases of the physical infrastructure providing entities and the brokering entity, the databases indicating a status of the physical resources; negotiating the services between the service providing entity and the brokering entity in order to determine an embedding solution with respect to the set of physical infrastructure providing entities according to an optimization criterion; instantiating the set of physical infrastructure providing entities of the determined embedding solution, wherein each physical infrastructure providing entity of the set of physical infrastructure providing entities instantiates a partition of the embedding solution.

By publishing the infrastructures, negotiating the services and instantiating the PIPs, the method allows the proper interactions among key players and enables the dynamic instantiation of virtual infrastructures required by service providers (SPs) to provide services to users.

In a first possible implementation form of the method according to the second aspect, the method comprises: rearranging the partition of the embedding solution by a particular physical infrastructure providing entity of the set of physical infrastructure providing entities based on changes in the physical resources managed by the particular physical infrastructure providing entity.

By the rearranging, the method is flexible to changes in the physical resources and modifications in the required services.

In a second possible implementation form of the method according to the second aspect as such or according to the first implementation form of the second aspect, the method comprises: rearranging the partition of the embedding solution by the brokering entity based on triggering conditions.

When rearranging the partition of the embedding solution by the brokering entity is based on triggering conditions, the method can efficiently react on inputs from outside.

In a third possible implementation form of the method according to the second aspect as such or according to any of the previous implementation forms of the second aspect, the embedding solution comprises virtualized network infrastructures host network functions represented by service graphs.

When the embedding solution comprises virtualized network infrastructures host network functions represented by service graphs, network infrastructures can be provided when they are required. This saves hardware costs.

In a fourth possible implementation form of the method according to the third implementation form of the second aspect, the service graphs comprise at least one of the following elementary functional blocks: processing components, forwarding components, storage components, and connections.

When the service graphs include processing components, forwarding components, storage components and connections, each network node can easily be represented by such a service graph.

The presented architecture described herein (comprising logical functions and logical interfaces) allows the proper interactions among key players in a future network ecosystem, enabling the dynamic instantiation of virtual infrastructures required by Service Providers to provide services to their users. The architecture gives details on internals of each of the involved players, identifying modules needed to achieve its goals and interactions (interfaces) between them.

The present disclosure provides a detailed architecture, describing the internals of these stakeholders as well as interfaces among them. The key to the architecture is: orchestration of resources done at the level of brokers and physical infrastructure providers, negotiation of service embeddings among them, SLA-aware service embeddings, SLA monitoring and resource description.

A further aspect of the patent application provides an Architecture or system for Service Embedding and Resource Orchestration in a future carrier network ecosystem where User, Service Provider (SP), Broker, Physical Infrastructure Provider (PIP) and Physical Resources (PR) are the key actors, the architecture comprising: a negotiator, an orchestrator, a monitoring agent, a resource manager and a database within the Broker; a negotiator, an orchestrator, a monitoring agent, a resource manager and a database within each PIP and interfaces Broker-PR, PIP-PR, PIP Broker and Broker-SP.

According to an implementation, the negotiator within the Broker performs the following tasks: keeping updated information within the Broker DB on available PIPs, receiving Service Requests from SPs and forwarding them to the Broker Orchestrator; negotiate and reserve resources with the PIPs negotiators for the services to be embedded; managing the offer for the proposed Service Request instantiation with the SPs, triggering the Solution Embedding procedure towards PIP negotiator.

According to an implementation, the Orchestrator within the Broker performs the following tasks: running the Partition Assignment Generation algorithm, by which the Service Request is split into sub graphs for an optimal embedding of the service request considering technical and pricing characteristics of available PIPs; running the Optimization and Reconfiguration algorithm to determine if an embedded service request shall be rearranged and re-embedded as a consequence of modified conditions at PIPs.

According to an implementation, the Resource Manager within the Broker performs the following tasks: allowing the broker to access physical resources; maintaining and managing the Access Info at brokers and towards SPs.

According to an implementation, the database within the Broker collects data relating to technical characteristics and pricing information of available PIPs.

According to an implementation, the negotiator within each PIP performs the following tasks: defining pricing and publishing criteria for the PRs relating to the PIP; updating and maintaining the PIP DB with PRs pricing and publishing information; managing the publication procedure towards the Broker Negotiator; Managing, at PIP side, the Negotiation and Resource Reservation procedure.

According to an implementation, the Orchestrator within each PIP performs the following tasks: running the Embedding Algorithm for the partition to be embedded; triggering the Instantiation Procedure towards the PIP RM; running the Optimization and Reconfiguration Algorithm to find alternative embedding solutions for the embedded partitions, whenever a change of PRs conditions occurs.

According to an implementation, the resource manager within each PIP performs the following tasks: handling the PR Registration Procedure within the Physical Infrastructure Publishing phase; performing the Instantiation Procedure towards PR, where virtual infrastructure are instantiated over physical machines; mapping high level requests from other functional blocks into low level commands specific to physical resources.

According to an implementation, the database within each PIP collects data relating to Physical Resources controlled by the PIP.

According to an implementation, the Broker-PR interface is dedicated to Access Information and Monitoring Data transfer.

According to an implementation, the PIP-PR interface is carrying the signaling needed for the PIP to discover (the PR resource Registration Procedure) and control the related PRs.

According to an implementation, the PIP Broker interface is carrying the signaling for the Physical Infrastructure Publication procure, Negotiation and Resource Reservation procedure, the Solution Embedding procedure, the Access Info Management procedure, and to transfer the Instantiation Request (+Access Info Procedure and Monitoring procedure).

According to an implementation, the Broker-SP interface is carrying the signaling required by the SP to issue the Service Request, to support the Offer And Negotiation procedure between the SP and the Broker, and to transfer to the SP the required Access Information.

A further aspect of the patent application provides a method for Service Embedding and Resource Orchestration in a future carrier network ecosystem where User, Service Provider (SP), Broker, Physical Infrastructure Provider (PIP) and Physical Resources (PR) are the key actors; the method is made by the following phases: Physical Infrastructure Publishing, Service Negotiation, Resource Instantiation, PIP Reconfiguration, Broker Reconfiguration.

According to an implementation, in the Physical Infrastructure Publishing phase, to reflect a change in PRs status, both PIP DB and Broker DB are updated.

According to an implementation, in the Service Negotiation phase, a Service Request sent by a SP is processed by the Broker and the optimal embedding solution is defined.

According to an implementation, in the Resource Instantiation phase, the selected embedding solution is instantiated, involving the best set of available PIPs, each PIP instantiating a partition of the solution to embed.

According to an implementation, in the PIP Reconfiguration phase, a PIP may decide to rearrange an embedded partition, when some changes in the PRs the PIP manages occur.

According to an implementation, in the Broker Reconfiguration phase, the Broker may decide to rearrange the embedded solution, when some relevant triggering conditions occur.

According to an implementation, in the method virtualized network infrastructures host network functions are described as service graphs.

According to an implementation, in the method network functions virtualization is achieved by embedding one or more network element described as graphs of elementary functional blocks such us processing components, forwarding components, storage components and connections.

The methods, systems and devices described herein may be implemented as software in a Digital Signal Processor (DSP), in a micro-controller or in any other side-processor or as hardware circuit within an application specific integrated circuit (ASIC).

The patent application can be implemented in digital electronic circuitry, or in computer hardware, firmware, software, or in combinations thereof, e.g. in available hardware of conventional mobile devices or in new hardware dedicated for processing the methods described herein.

### BRIEF DESCRIPTION OF THE DRAWINGS

Further embodiments of the patent application will be described with respect to the following figures, in which:

FIG. 1 shows one example of a currently proposed future carrier network ecosystem 100;

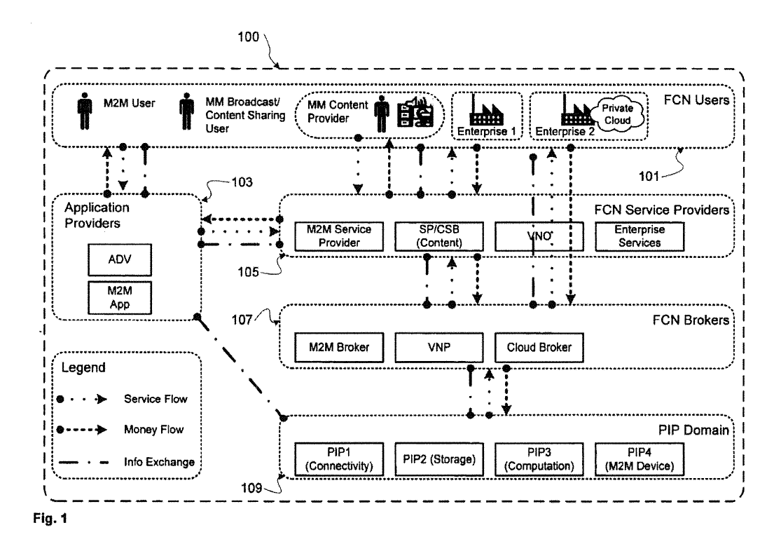

FIG. 2 shows one example illustrating a future carrier network reference scenario 200 according to an implementation form;

FIG. 3 shows one example illustrating a high level future carrier network architecture 300 according to an implementation form;

FIG. 4 shows a schematic diagram illustrating an overview of a communication method 400 between components of the future carrier network architecture depicted in FIG. 3 according to an implementation form;

FIG. 5 shows a sequence diagram illustrating one example of a physical infrastructure publishing phase 500 as depicted in FIG. 4 according to an implementation form;

FIG. 6 shows a sequence diagram illustrating one example of a service negotiation phase 600 as depicted in FIG. 4 according to an implementation form;

FIG. 7 shows a sequence diagram illustrating one example of a resource instantiation phase 700 as depicted in FIG. 4 according to an implementation form;

FIG. 8 shows a sequence diagram illustrating one example of a reconfiguration phase 800 for a PIP as depicted in FIG. 4 according to an implementation form;

FIG. 9 shows a sequence diagram illustrating one example of a reconfiguration phase 900 for a Broker as depicted in FIG. 4 according to an implementation form;

FIG. 10 shows a sequence diagram illustrating one example of a de-instantiation phase 1000 for a PIP as depicted in FIG. 4 according to an implementation form;

FIG. 11 shows a sequence diagram illustrating one example of a de-instantiation phase 1100 for a Broker as depicted in FIG. 4 according to an implementation form;

FIG. 12 shows a sequence diagram illustrating one example of an interaction 1200 between a mobile virtual network operator and a Broker according to an implementation form;

FIG. 13 shows a sequence diagram illustrating one example of an interaction 1300 between a Broker and a PIP for a mobile virtual network operator network realization according to an implementation form;

FIG. 14 shows a schematic diagram illustrating one example of a service graph 1400 of a portion of an Evolved Packet System according to an implementation form; and

FIG. 15 shows a schematic diagram illustrating a method 1500 for service embedding and resource orchestration in a future carrier network architecture as depicted in FIG. 3 according to an implementation form.

### DETAILED DESCRIPTION

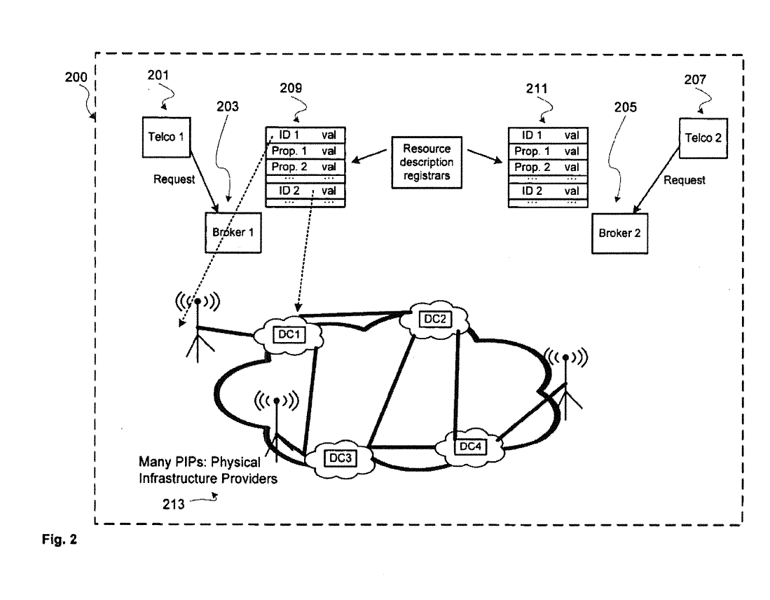

FIG. 2 shows one example illustrating a future carrier network reference scenario 200 according to an implementation form.

Embodiments apply to a future carrier network scenario 200 where a plurality of physical infrastructure providers 213 will coexist to enable provisioning of various services to end users. Services are not directly provisioned by the PIPs 213. Instead, service providers 201, 207 rent infrastructure from appropriate PIPs 213. Therefore, the appropriate model in this case is IaaS (infrastructure as a service). The main difference to already established IaaS offerings is that service providers may rent infrastructure from multiple PIPs 213, rather than one. They do that through brokers 203, 205 who specialize on maintaining information on available infrastructure at various PIPs and on interacting with PIPs in order to distribute service providers' 201, 207 request onto the selected infrastructure in a most cost efficient way. This is depicted in FIG. 2.

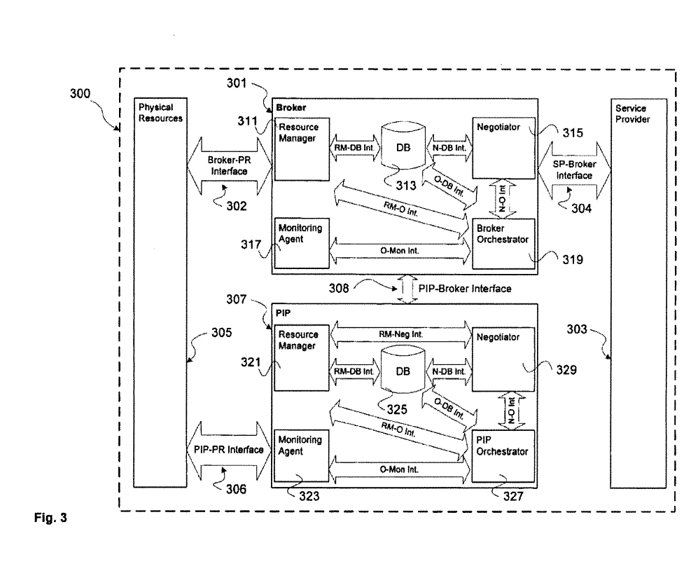

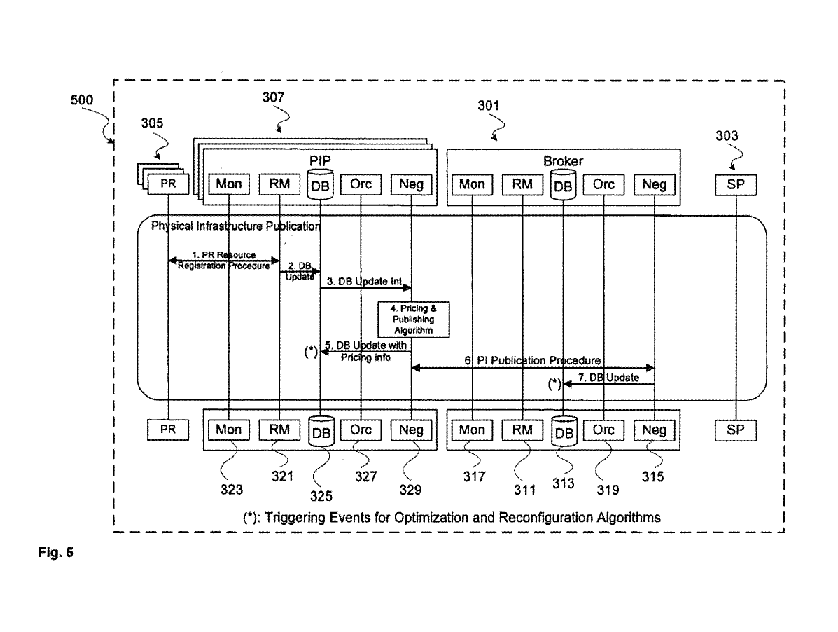

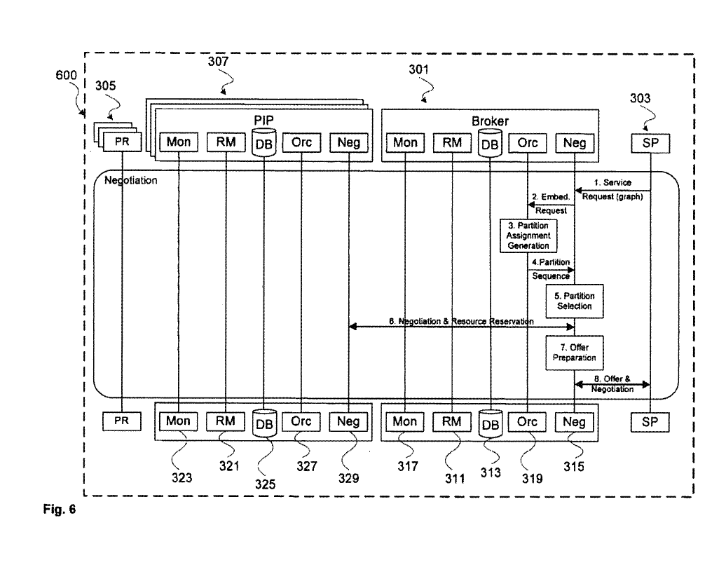

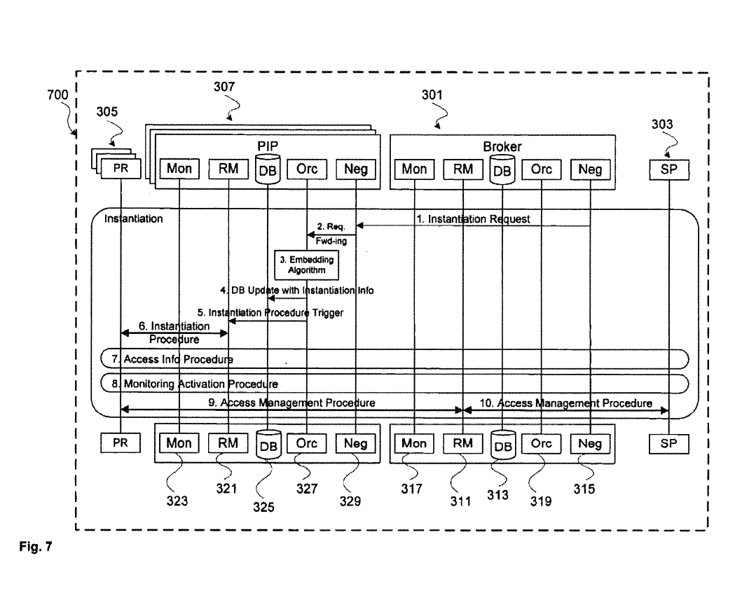

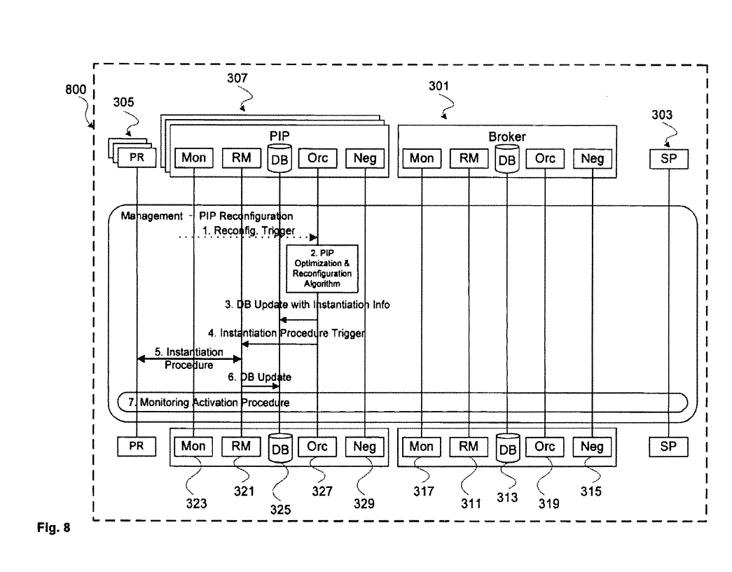

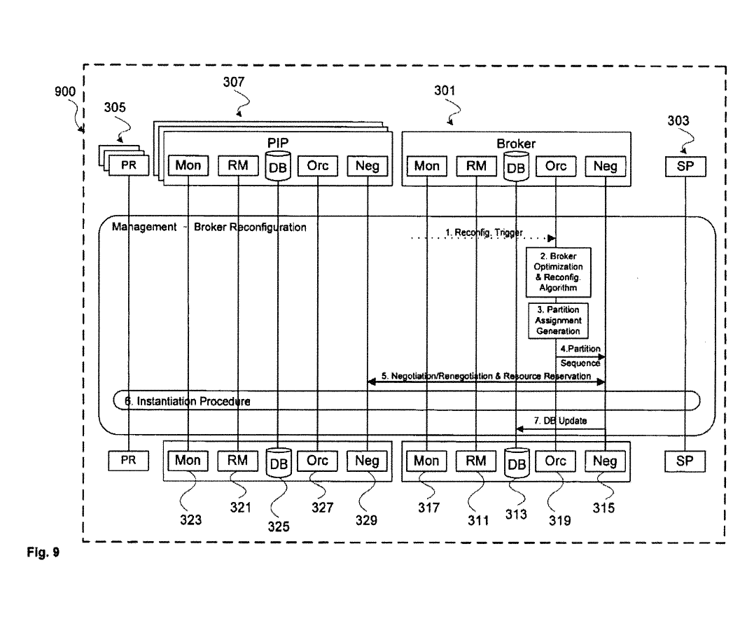

To realize such a scenario, the key is to understand the needed interaction between the brokers 203, 205 and the PIPs 213, as well as between the service providers 201, 207 and the brokers 203, 205. Brokers 203, 205 maintain registries 209, 211 of available physical resources, i.e. PIPs 213 make this information available to the brokers 203, 205. Details on this are described below with respect to FIG. 5. A broker 203, 205 receives a service request from a service provider 201, 207. This service request may be expressed in terms of a graph with clearly specified semantics. More details on this are given in below with respect to FIG. 3. The broker 203, 205 then tries to find the most effective way to distribute this graph onto the infrastructure of PIPs 213 it knows of. A more detailed description of this interaction is given below with respect to FIG. 6, along with the brokers' 203, 205 and PIPs' 213 internals needed to enable this interaction. Once a request from a broker 203, 205 is accepted, an involved PIP 213 needs to reserve resources and expose appropriate control interfaces towards the broker 203, 205 and/or service provider 201, 207. That process if explained below with respect to FIG. 7. Finally, each PIP 213 needs to monitor its resources and perform reassignment of virtual to physical resources from time to time, create and process alarms in case of SLA violations and so on. Details on these aspects of PIPs operation are described below with respect to FIGS. 8 and 9.

FIG. 3 shows one example illustrating high level future carrier network architecture 300 also denoted as system for service embedding and resource orchestration according to an implementation form. FIG. 3 illustrates the main actors in the FCN architecture 300 as well as the main functional blocks of those actors needed to realize the tasks associated with these actors. Both broker 301 and the PIP 307 have the following functional blocks: Orchestrator 319, 327, Negotiator 315, 329, Resource manager 311, 321, Monitoring functional block (Monitoring agent) 317, 323 and Database 313, 325 to hold all relevant information.

However, the logic built into these modules, the information maintained in the databases and the algorithms executed in them are slightly different for PIPs 307 and brokers 301. The main scenario that the architecture from FIG. 3 is supposed to enable is as follows. A broker 301 receives a service request from a Service provider (not shown in the figure). This service has a graph form, essentially providing information about what resources the provider needs and what their properties should be (SLA). More details are provided below in this section. The broker's goal is to divide this graph into a number of subgraphs and distribute these to the most appropriate PIPs 307. The broker 301 has to find such a distribution of the original graph that is the most cost-effective. At the same time, the service needs to fulfill the SLA requirements initially specified by the service provider.

On the side of PIPs 307, whatever request is accepted to be hosted at the PIP's 307 infrastructure, a PIP-internal orchestrator 327 makes sure that the request is mapped onto the physical infrastructure in a way that optimizes the internal goals of the PIP 307.

To realize this, the following functional blocks within the broker 301 and the PIPs 307 are used and described as follows:

Each PIP 307 includes the functional blocks Orchestrator 327, Negotiator 329, Resource Manager 321, Monitoring Agent 323 and database 325.

The Orchestrator 327 is responsible for finding an optimal mapping (assignment) of brokers' requests to the underlying physical infrastructure. A typical example of optimization performed by the orchestrator is maximizing the number of service requests arriving from various brokers to be embedded into the physical infrastructure of the PIP.

The Negotiator 329 maintains logic to assess if a request from a broker will be accepted or not. It can contact the orchestrator to calculate if it is possible to embed the request into the current infrastructure and, if possible, to calculate the state of physical infrastructure when the request is realised. The negotiator may implement a complex mapping from a number of input variables to a (set of) price(s) to be exposed to brokers, i.e. made public. The input variables should be: state of own individual resources, histories of request (translating into beliefs about future requests) and, optionally, prices of other PIPs.

The Resource Manager (RM) 321 at PIP 307 is the functional block responsible for the direct management of physical resources (PR). The PIP RM interacts with the PR Resource Controller. The RM handles the PR Registration Procedure within the Physical Infrastructure Publishing phase and performs the Instantiation Procedure towards PR, where virtual infrastructure are instantiated over physical machines. In a sense, it serves as a driver, mapping high level requests from other functional blocks into low level commands specific to physical resources.

The Monitoring agent 323 is responsible as follows: Each physical or virtual resource hosting a service graph's component is monitored to verify the fulfillment of the offered SLA. This is the main task of the monitoring agent. The PIP orchestrators may consider the reports as an input to re-calculate the embedding of the service graphs.

The Broker 301 includes the functional blocks Orchestrator 319, Negotiator 315, Resource Manager 311, Monitoring Agent 317 and database 313.

The Orchestrator 319 is responsible for splitting the service request (that may come in form of a graph) from a service provider into pieces and distributing them to the PIPs. The orchestrator may try to find the service splitting with the minimum price. (Note that the service providers' request for an optimal service in any sense, e.g. minimum energy consumption for a green operator, will not prevent the broker to perform its price optimal service graph splitting.) The service requirements (SLA) are taken as constraints that have to be satisfied. The prices published by the PIPs are used to estimate the service price (normally, by summing up the prices of all resources across all splitting of the considered service). Prices as described herein do not only contain a monetary aspect but also aspects related to technical complexity, such as computational complexity, hardware and/or software complexity.

The Negotiator 315 is responsible for making a price offer to the service provider. Similar to the negotiator of a PIP, a broker's negotiator collects a number of inputs and maps them into a price to be offered to the service provider. The input can be (but are not limited to): the price estimate from the PIPs, possibly estimates of what other brokers might offer for the same request, history of deals made with the service provider in question and so on.

The Resource manager 311 is responsible as follows: A broker's resource manager maintains the broker's management access to the relevant physical and virtual resources. Unlike the PIP's RM, it does not provide mapping of high level requests to the low level commands suitable to physical resources, but may only be responsible for maintaining and managing the access info for the management of the virtual infrastructure at brokers and SPs.

The Monitoring agent 317 is responsible as follows: the Monitoring Agent 317 at the Broker 301 is responsible for the management of the global monitoring of the whole instantiated virtual infrastructure. For each Service Request instantiated, the Monitoring Agent collects monitoring data from all concerned PIPs, assesses performance for the instantiated infrastructure, verifies compliance to established SLAs, and triggers countermeasures, in case SLAs are not fulfilled.

The service provider communicates the service requests in the form of a service graph, a description of functional blocks and connectivity constraints among them. Each component is characterized by the requested capacity and Service Level attributes.

In one embodiment, the service graph may be of purely infrastructural nature containing processing components, storage components and connectivity requirements. Processing components are characterized by capacity requirements such as number of CPUs and amount of memory (RAM) and, optionally, the geographical location. Storage components may be an amount of storage and, optionally, the geographical location. Connectivity requirements may be as follows: Between the components that have data dependencies, the graph specifies the bandwidth and latency requirements of the connections.

In another embodiment, the functional blocks of the service graph are software components compliant with standard specifications, such as network elements described by standardization organization like ETSI, IETF, etc. In this case, the requirements assigned to each functional block are related to the dimensioning of the network elements, e.g. features to be supported, number of users per service type, coverage area, etc. Each service graph component may be also characterized by Service Level (SL) attributes, organized in two sections such as data policies and business policies. Data policies are defining constraints related to resources availability, redundancy, data location, preservation and privacy. Business policies may be guarantees, payment and penalty models.

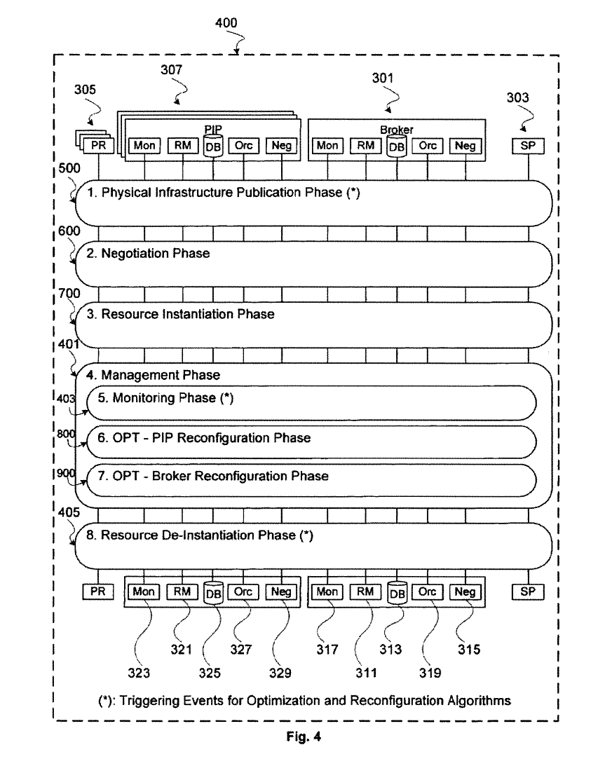

FIG. 4 shows a schematic diagram illustrating an overview of a communication method 400 between components of the future carrier network architecture depicted in FIG. 3 according to an implementation form. FIG. 4 describes operational details of the architecture described above with respect to FIG. 3. It is specified what each of the involved components is supposed to do and how they contribute to realizing the final goal of the architecture, pooling physical resources together and delivering customer services from a set of physical resources that may belong to different physical infrastructure providers. The description consists of a number of sequence diagrams, which illustrate the main functions to be realized. FIG. 4 shows an overview of the disclosed method, where key phases are highlighted.

The Physical Infrastructure Publication phase 500: this phase is triggered whenever a change in the status of any Physical Infrastructure (PIs) relating to any PIP occurs. This phase allows both PIP DBs and Broker DBs to be updated at any time, according to the latest status of available PIs. Details on this phase are described below with respect to FIG. 5.

The Negotiation Phase 600: this phase is triggered when a SP issues a Service Request to the Broker. During this phase, the Broker defines the optimal embedding solution (according to economic and technical criteria) for the Service Request, identifying the optimal partitioning among available PIPs, reserving the required resources at the involved PIPs, and negotiating SLA and price with the SP; Details on this phase are described below with respect to FIG. 6.

The Resource Instantiation Phase 700: this phase is triggered whenever a Negotiation Phase is successfully concluded. During this phase, the Broker commands the instantiation of the defined embedded solution to the involved PIPs; After the virtual infrastructure is instantiated, Access Information is distributed to Broker and SP, and the monitoring of virtual infrastructure is initialized; Details on this phase are described below with respect to FIG. 7.

The Management Phase 401: after the instantiation has been successfully completed, the instantiated infrastructure is managed by the involved parties. The Management Phase 401 may include a Monitoring Phase 403, PIP reconfiguration phase 800 and a Broker reconfiguration phase 900.

The Monitoring Phase 403 is as follows: during the Management Phase, the Monitoring Phase also continuously takes place. The purpose of this phase is to monitor the status of all involved resources in order to assess system performance, verify SLAs fulfilment, and eventually trigger infrastructure reconfiguration.

The PIP reconfiguration Phase 800 is triggered whenever at a given PIP some conditions occur, making an embedded solution not anymore optimal. During this phase, the concerned PIP devises and instantiates a new embedding solution. This phase is transparent to both Broker and SP. Details of this phase are described below with respect to FIG. 8.

The Broker Reconfiguration Phase 900 is triggered whenever some conditions, making an embedded solution not anymore optimal from Broker perspective, occur. During this phase, the Broker evaluates the opportunity to redefine the partition for the Service Request, renegotiates and reserves resources with the concerned PIPs, and triggers the instantiation procedure. Details of this phase are described below with respect to FIG. 9.

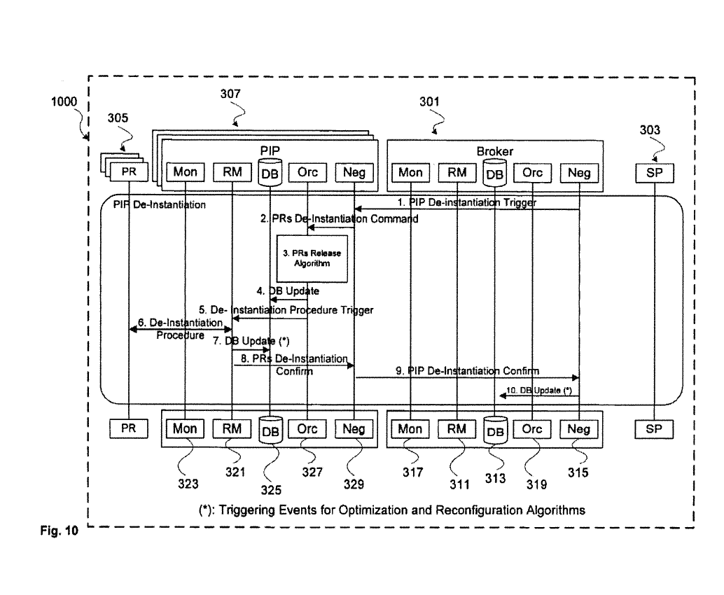

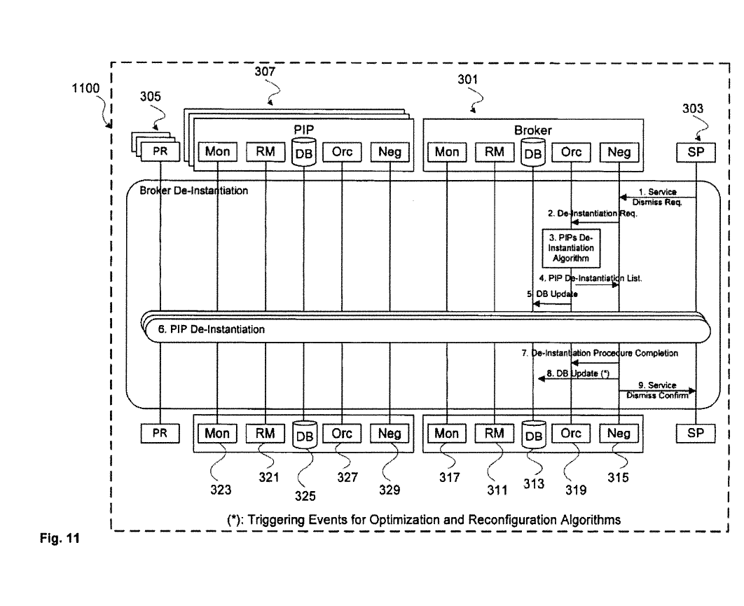

The Resource De-instantiation Phase 405 is triggered by de-instantiation requests originated by the Broker or the PIP. Details of this phase are described below with respect to FIGS. 10 and 11.

FIG. 5 shows a sequence diagram illustrating one example of a physical infrastructure publishing phase 500 as depicted in FIG. 4 according to an implementation form.

The publication phase 500 is triggered when a) a new Physical Resource (PR) is integrated in a PIP's infrastructure; b) a PR belonging to a PIP has updated attributes; and c) on de-registration/withdrawal of a resource. The purpose of the publication is the update the Resources Databases (DB) of the PIP as well as the DBs of the Brokers having visibility on that PIP's infrastructure.

The publication phase 500 consists of the following steps:

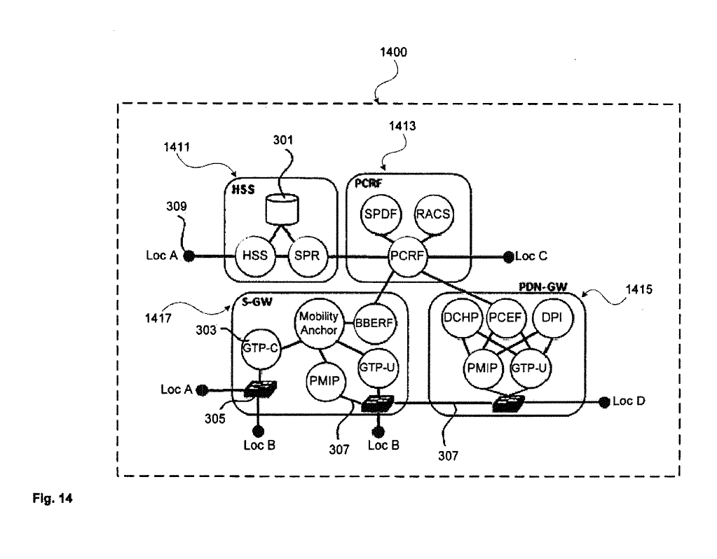

1) The registration phase of the resource is initiated by a resource Registration Procedure, which is handled by the Resource Manager (RM) in the PIP. The RM performs the Registration Procedure interacting with the Controller of the PR; the nature of the procedure depends on the resource type. Some examples of PR Controllers are introduced as specific embodiment described below with respect to FIG. 14.

2) After collecting the information about the resource, the RM translates the resource attributes in a Resource Description. The resource description generated by the RM involves, but is not restricted to, the following attributes:
A1. A unique resource identifier;
A2. The resource type;
A3. A reference to the Controller which handles the resource;
A4. The capacity attributes of the resource;
A5. The Service Level Data policies.

If the resource is new, the PIP RM creates a new entry in the PIP DB. If the resource was updated, the PIP RM updates the resource description in the PIP DB.

3) The PIP DB informs the PIP Negotiator of the update, sending a message that includes the DB reference and the resource description.

4) The PIP Negotiator executes a Pricing & Publishing (P2) algorithm to generate the following resource description attributes:
A6. Pricing;
A7. The Service Level Business policies;
A8. The visibility attributes, used to identify the Brokers allowed viewing the resource.
   This step may involve interrogating the PIP DB.

5) The PIP Negotiator updates the database, storing the PR attributes generated by the P2 algorithm. The database update may trigger a reconfiguration phase in the PIP, according to the procedure as described below with respect to FIG. 8.

6) By starting a Physical Infrastructure Publication Procedure with the Broker Negotiator, the PIP Negotiator informs all the Brokers allowed viewing the resource. The PIP Negotiator dispatches the resource description including the attributes from A1, A2, A4, A5, A6 and A7. The content of the attributes might be filtered according to the visibility attributes (A8) of the resource.

7) The Broker Negotiator updates the Broker DB, storing the resource description received from the PIP. The Broker Negotiator may add visibility attributes, used to identify the Service Providers having right to use the resource. The database update may trigger a reconfiguration phase in the Broker, according to the procedure described below with respect to FIG. 9.

FIG. 6 shows a sequence diagram illustrating one example of a service negotiation phase 600 as depicted in FIG. 4 according to an implementation form.

The service negotiation phase 600 is crucial for the operation of the architecture presented herein. The steps are shown in FIG. 6 can be explained as follows.

Step 1: The Service provider sends a service request to the broker. This request may be communicated in form of a graph which contains all SLA constraints that the service provider expects to be fulfilled.

Step 2: The service request is received by the negotiation module of the broker. The negotiator saves the information about the request, contact data of the service provider for further communication with it and so on. The negotiator forwards the service request to the broker's orchestrator.

Step 3: The orchestrator runs an algorithm to find (possibly multiple) optimal partitions of the service request graph to multiple PIPs. This algorithm is the key for a successful operation of the broker. Each partition is a full list of mappings specifying what part of the service graph is transferred to which PIP. Every node and edge has to be covered by this list. In an implementation, a configuration parameter of the broker shows how many such partitions should be delivered as result of the orchestrator's operation. Optimality of a partitioning is defined in terms of its total cost that is charged by the involved PIPs. The individual costs of the PIPs, i.e. their estimates, are present in the broker's DB. They are published periodically by the PIPs, as described above with respect to FIG. 5.

Step 4: The partitions are collected by the negotiator.

Step 5: The negotiator starts contacting the concerned PIPs. It can happen that the information based on which a concerned service partition has been made is not up to date, i.e. resources announced by a PIP are no longer available or the prices have changed. The purpose of this step is to verify whether this has happened or not. In case it has not, the resources needed by the broker are reserved at all the involved PIPs. Notice the atomicity of this step: either needed resources are reserved at all involved PIPs or at none of them.

Step 6: After a successful resource reservation the phase of negotiation between the broker and service provider can start. The price of the request is set in this step. The broker has the costs imposed by the PIPs and tries to charge the service provider at least this amount. An important note for this phase is that the negotiator may at its discretion contact the orchestrator for new partitions or a re-evaluation of existing partitions since the prices maintained in the databases are significantly different from the current prices the negotiator finds.

Step 7: Based on the outcome of negotiating with the PIPs in Step 6, the broker can prepare multiple offers for the service provider.

Step 8: The offers prepared in Step 7 are communicated to the SP who can then choose one of those offers.

After a deal has been made between the broker and the service provider, the broker informs the involved PIPs and issues a request to embed the physical resources. The embedding procedure of the PIPs and exposing the embedded resources to the broker and the service provider are presented in the following sections.

FIG. 7 shows a sequence diagram illustrating one example of a resource instantiation phase 700 as depicted in FIG. 4 according to an implementation form.

The instantiation phase 700 starts as a result of the negotiation phase when a PIP receives a request for instantiating a service graph. The instantiation phase 700 comprises the following steps:

Step 1: The PIP negotiator receives a go ahead for embedding the service graph onto the physical infrastructure he owns. The service graph specifies (not limited to) the service that needs to be installed and any other supporting info that may be required, such as, the access and monitoring details.

Step 2: The negotiator verifies that the request and the price offered is in compliance with what was agreed during the negotiation phase and forwards the service graph request to the PIP orchestrator. See Step 6 as described above with respect to FIG. 6.

Step 3: The orchestrator then executes the embedding algorithm optimizing the placement of the virtualized components over the physical infrastructure. This optimization may be based on service provider requested parameters (SLA policies in the requested Service Graph, introduced above with respect to FIG. 3) or the PIPs own parameters (SLA policies in the Resources Description attributes A5 and A7, introduced above with respect to FIG. 5) in accordance with the contract set in the negotiation phase.

Step 4: This virtual resource to physical resource map is saved in the DB.

Step 5: The Orchestrator triggers the RM to instantiate these virtual machines in the physical resources.

Step 6: The RM instantiates the virtual infrastructure over the physical infrastructure using the virtualization control infrastructure exposed by them.

Step 7: Once the instantiation succeeds the RM provides the access credentials and other supporting information to the broker RM. These credentials are important for managing the service by the SP. The broker RM saves this access info to the broker database and also forwards it to the SP.

Step 8: Parallel to step 7 the monitoring infrastructure for monitoring the performance of the service and reporting it to the broker as well as the SP is also set up.

Step 9-10: The SP or the broker may then directly access the virtual infrastructure for network/service configuration and other management issues.

FIG. 8 shows a sequence diagram illustrating one example of a reconfiguration phase 800 for a PIP as depicted in FIG. 4 according to an implementation form.

Various events during the operation of the embedded virtual network may trigger reconfiguration. An example of such a trigger is the discovery of a new significantly cheaper resource, a more energy efficient embedding or failure of one of the existing resources. The reconfiguration maybe triggered at the broker or at the PIP level.

PIP reconfiguration trigger requests the orchestrator to evaluate if a more optimal embedding is possible. This optimization may be slightly different from the embedding algorithm due to further constraints than the orchestrator may need to fulfill (e.g. the access network should not be affected; the re-configuration is invisible to the service being hosted).

The reconfiguration phase 800 may comprise the following steps:

Step 1: The PIP orchestrator receives a trigger for reconfiguration. Possible triggers are: DB update with pricing info in the Physical Infrastructure Publishing Phase (see description above with respect to FIG. 5); DB update in the PIP De-instantiation phase (see description below with respect to FIG. 10); and Trigger from the Monitoring Agent.

Step 2: The orchestrator evaluates if re-configuration is required. The evaluation algorithm is similar to an embedding algorithm but has additional constraints like the new embedding should have the same access info and service state as the existing one.

Step 3: If the orchestrator decides that a reconfiguration is needed then the DB is updated with the new virtual to physical infrastructure mapping.

Step 4: The instantiation for the new embedding is then triggered by the orchestrator to the RM.

Step 5: The RM instantiates the network using the interfaces supported by the physical resources.

Step 6: The RM also internally updates the PIP DB when the instantiation is successful.

Step 7: The monitoring is reconfigured in accordance with the new embedding map to monitor the appropriate physical and virtual machines.

FIG. 9 shows a sequence diagram illustrating one example of a reconfiguration phase 900 for a Broker as depicted in FIG. 4 according to an implementation form.

The Broker reconfiguration phase 900 is similar to the negotiation phase 600 presented above with respect to FIG. 6. Broker reconfiguration trigger requests the broker orchestrator to evaluate if a more optimal partitioning is possible. Similar to the PIP case the optimization may be slightly different from the initial embedding algorithm due to the further constraints the algorithm may need to fulfill (e.g. access network should not be affected).

The Broker reconfiguration phase 900 may comprise the following steps:

Step 1: The trigger to reconfigure may also happen at the broker layer because; the list of possible triggers is: a) DB update in the Physical Infrastructure Publishing Phase (see description above with respect to FIG. 5); b) DB update in the PIP De-instantiation phase (see description below with respect to FIG. 10); c) DB update in the Broker De-instantiation phase (see description below with respect to FIG. 11) and d) Trigger from the Monitoring Agent.

Step 2: The orchestrator decides if reconfiguration is required based on the information about the PIPs it has in the DB.

Step 3: If reconfiguration is required then the new partitioning of the resources between PIPs is calculated by the orchestrator service graph partitioning algorithm.

Step 4: The orchestrator then communicates the new partitioning to the negotiator.

Step 5: The broker negotiator confirms/re-negotiates the information with the PIP negotiator and reserves the resources. An important note for this phase is that the negotiator may at its discretion contact the orchestrator for new partitions or a re-evaluation of existing partitions since the prices maintained in the databases are significantly different from the current prices the negotiator finds.

Step 6: The above steps are followed by an instantiation phase in the PIPs which involves instantiating new resources and/or migrating or deleting older ones. The instantiation phase is described above with respect to FIG. 6.

Step 7: At the successful completion of the PIP instantiation phase the broker DBs are updated with all the changes.

FIG. 10 shows a sequence diagram illustrating one example of a de-instantiation phase 1000 for a PIP as depicted in FIG. 4 according to an implementation form.

The de-instantiation 1000 of resources in the PIP can be triggered by a de-instantiation request originated by the Broker.

The de-instantiation phase 1000 for a PIP comprises the following steps:

Step 1: The Broker Negotiator triggers the PIP de-instantiation by sending a message to the PIP Negotiator; the message identifies the service graph that needs to be de-instantiated.

Step 2: The PIP Negotiator verifies that the request is in compliance with what was agreed during the negotiation phase and forwards the service graph request to the PIP orchestrator.

Step 3: The PIP orchestrator then executes the PRs Release Algorithm, which could involve retrieving from the PIP DB supporting info that may be required, such as, list of the resources associated to the graph, the access details and monitoring details.

Step 4: The PIP orchestrator updates the PIP DB, specifying that the graph and the associated resources are in de-instantiation phase.

Step 5: The PIP Orchestrator triggers a de-instantiation procedure in the PIP RM, identifying the virtual resources to be de-instantiated.

Step 6: The PIP RM de-instantiates the virtual resources and the monitoring instances from the physical infrastructure using the virtualization control infrastructure.

Step 7: The PIP RM updates the database; this operation may trigger (*) the PIP reconfiguration procedure as described above with respect to FIG. 8.

Step 8: The PIP RM confirms the de-instantiation to the PIP Negotiator.

Step 9: The PIP Negotiator confirms the de-instantiation of the service graph to the Broker Negotiator; the message contains an update of the list of available resources in the PIP.

The Broker Negotiator removes the service graph and updates the list of available resources in the Broker DB; this operation may trigger a Broker reconfiguration according to the procedure described above with respect to FIG. 9.

FIG. 11 shows a sequence diagram illustrating one example of a de-instantiation phase 1100 for a Broker as depicted in FIG. 4 according to an implementation form.

The de-instantiation 1100 of service graphs in the Broker and, as a consequence, of resources in the PIP can be triggered by a service dismiss request originated by the Service Provider.

The de-instantiation phase 1100 for a Broker may comprise the following steps:

Step 1: The Service Provider sends a Service Dismiss Request to the Broker Negotiator, identifying the service graph or portion of service graph to be dismissed.

Step 2: The Broker Negotiator verifies whether the request is compliant with the SLA Business Policies associated to the service and forwards the de-instantiation request to the Broker Orchestrator.

Step 3: The Broker Orchestrator runs the PIPs de-instantiation algorithm to generate the list of Service sub-graph to be de-instantiated.

Step 4: The Broker Orchestrator sends the PIP de-instantiation list to the Broker Negotiator.

Step 5: The Broker orchestrator updates the Broker DB, specifying that the graph and sub-graphs are in de-instantiation phase.

Step 6: The Broker Negotiator originates PIP de-instantiation triggers to the relevant PIPs, according to the procedure described above with respect to FIG. 10; This step includes the broker de-instantiating all access and monitoring instances relevant to each PIP administered by the broker.

Step 7: After receiving the de-instantiation confirm from all the PIPs involved in the implementation of the service graph, the Broker Negotiator completes the de-instantiation procedure by informing the Broker Orchestrator of the results of the de-instantiations in the PIPs.

Step 8: Finally the Broker Negotiator updates the Broker database removing the service graph; this operation may trigger a Broker reconfiguration phase according to the procedure described above with respect to FIG. 9, in order to reconfigure service sub-graphs having dependencies on the dismissed service.

Step 9: The Broker Negotiator sends a Service Dismiss confirm to the SP.

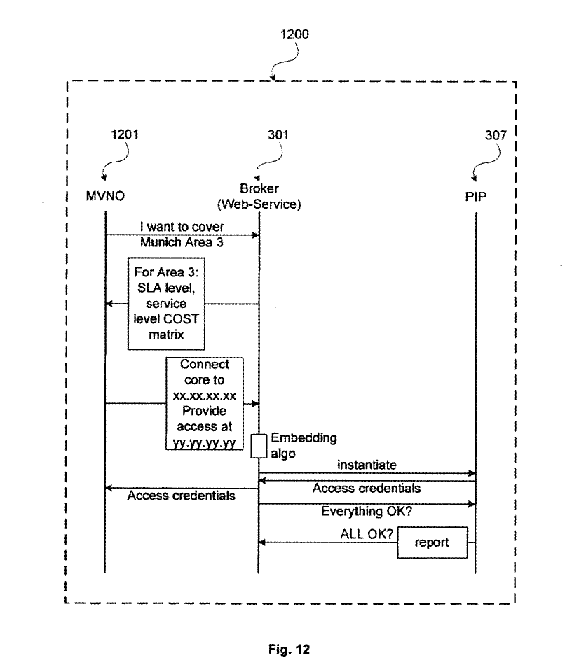

FIG. 12 shows a sequence diagram illustrating one example of an interaction 1200 between a mobile virtual network operator 1201 and a Broker 301 according to an implementation form.

In an embodiment the operation of mobile virtual network operators (MVNOs) can be realized. MVNOs 1201 may be mobile operators companies who do not own their own infrastructure but rent a share of other physical mobile network operators (MNOs). In the current situation MVNOs may be charged on a data volume based model which hides infrastructure operation and management costs. MNOs 1201 may be enabled to charge based on different levels of service and SLA provided to the MVNO 1201. In addition, MNOs may be enabled to expose the MVNOs part of the infrastructure for self-operation and management of the MVNO infrastructure.

In an embodiment, a brokerage service offers network coverage for, the Munich area for example as shown in FIG. 12. The service offered can involve different areas covered in Munich and different SLAs supported to the user and different levels of management service offerings for the MVNO. For example, the broker may provide “Munich ring 5-16 coverage, at SLA of minimum 1 MB, maximum 10 MB connection to the core for approx. 10000 users with minimum 1000 users connecting simultaneously, and another 500 minimum simultaneous calls. “I as MVNO want the best service and will not do any O&M myself”. In this embodiment this expression is closer to a legal contract definition and maybe different from a service graph.

A broker may maintain a standard list of such legal offers which may be fine-tuned by the MVNO (For example number of people and the SLAs per user to be supported). Based on this in this embodiment the broker orchestrator self-creates a service graph of a mobile network to support the MVNO operations in this area. The graphs include the number and locations of base stations, eNBs, MMEs, SGSNs and all other network functions required to support a mobile operator network. Doing so implies that this broker understands the details of the network functions compromising a mobile network. This calculation of the self-graph can be further optimized since it can be created in a way that is already be optimized by the orchestrator to the physical resources it know the PIPs 307 have.

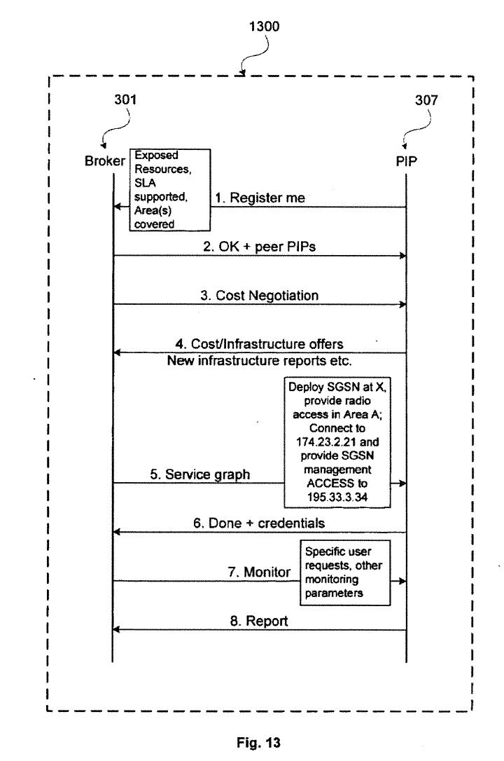

FIG. 13 shows a sequence diagram illustrating one example of an interaction 1300 between a Broker 301 and a PIP 307 for a mobile virtual network operator network realization according to an implementation form.

The broker 301 negotiates with the PIPs 307 on parts of this service graph for an agreeable cost. Based on the successful result of the negotiation with the appropriate PIPs a part of the service graph to be realized by the PIP is sent to the PIP for instantiation. The PIPs instantiate their service graph parts using control interfaces provided by physical infrastructure, for example “openflow”. Once the network is created the PIPs provide the access credentials back to the broker which in turn may forward it to the SP. At this point the broker 301 begins monitoring the PIP network for the correct functioning of the provisioned network.

From FIG. 13 can be seen that the Broker 301 and the PIP 307 may need to understand particular network functions to realize a complete mobile (or other) network. For example to realize a complete 3G network knowledge of for example how to realize an IMS system is required. FIG. 14 described below illustrates an embodiment to realize such “Network functions” in a virtualized environment.

FIG. 14 shows a schematic diagram illustrating one example of a service graph 1400 of a portion of an Evolved Packet System (EPS) according to an implementation form.

Embedding Carrier grade network functions over Cloud Computing technologies is a significant embodiment of this disclosure. Network Elements such as switching elements (routers, BNG) and mobile network nodes (HLR/HSS 1411, MME, SGSN, GGSN/PDN-GW 1415 . . . ) could be hosted in Commercial-off-the-shelf IT-platforms. Each Network Element can be formally described by a Service Graph as a structure of elementary functional blocks and connectivity requirements among them. A service graph may also describe a portion of network. As an example, FIG. 14 shows the Service Graph 1400 of a portion of an EPS network. In accordance to the embodiment of service graphs described above with respect to FIG. 3, the graph 1400 is issued in the form of an application workflow. The application workflow splits the service in processing components 1403, forwarding elements 1405, storage components 1401 and connections 1407. At the periphery of the service graph 1400, the connections may end up to empty components 1409, characterized only by their geographical location.

The Broker may be an OSS/BSS functional block in charge of embedding network functions in the infrastructures offered by one or more PIPs. In this case the service graphs might convey the dimensioning requirements issued by a network planning department of a Telco operator.

The PIPs operate physical infrastructures and translate them into virtual resources by means of virtualization controllers, such as: Network controllers, e.g. OpenFlow controllers, managing virtual infrastructures based on general purpose switching gears; IT middleware controllers, e.g. OpenStack components, exposing data centers resources like virtual machines, virtual switches and storage elements; and Radio access controllers managing wireless access points.

Each PIP publishes the virtual resources to one or more Brokers. Each Broker splits network graphs into sub-graph by means of embedding algorithms. The PIPs embed network sub-graph into virtual resources; the PIP Resource Manager translate the virtual resource requirements for the underlying virtualization controller.

Running network functions on top of general purpose hardware and sharing wireless access points may allow significant costs reduction for the Telco operators. The Orchestration of network functions can enable re-allocating slices of infrastructure to different Network Elements according to evolving dimensioning requirements, replacing networking technologies by re-using existing infrastructures or rearranging the geographical distribution of the network functions according to the location of the connected devices.

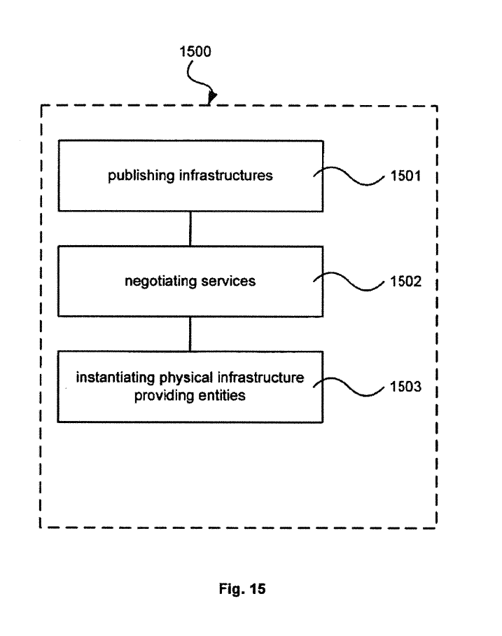

FIG. 15 shows a schematic diagram illustrating a method 1500 for service embedding and resource orchestration in a future carrier network architecture as depicted in FIG. 3 according to an implementation form.

The method 1500 can be applied in a system 300 as described above with respect to FIG. 3, i.e. a system 300 comprising a service providing entity 303 for providing services to users, a set of physical infrastructure providing entities 307 for providing infrastructures made by physical resources 305 and a brokering entity 301 for providing the service providing entity 303 with the infrastructures from the physical infrastructure providing entities 307. The method 1500 includes: publishing 1501 the infrastructures and updating databases 325, 313 of the physical infrastructure providing entities 307 and the brokering entity 301, the databases 325, 313 indicating a status of the physical resources 305. The method 1500 further includes: negotiating 1502 the services between the service providing entity 303 and the brokering entity 301 in order to determine an embedding solution with respect to the set of physical infrastructure providing entities 307 according to an optimization criterion. The method 1500 further includes: instantiating 1503 the set of physical infrastructure providing entities 307 of the determined embedding solution, wherein each physical infrastructure providing entity 307 of the set of physical infrastructure providing entities 307 instantiates a partition of the embedding solution.

In an implementation, the method 1500 includes: rearranging the partition of the embedding solution by a particular physical infrastructure providing entity 307 of the set of physical infrastructure providing entities 307 based on changes in the physical resources 305 managed by the particular physical infrastructure providing entity 307.

In an implementation, the method 1500 includes: rearranging the partition of the embedding solution by the brokering entity 301 based on triggering conditions.

In an implementation, the method 1500 includes that the embedding solution comprises virtualized network infrastructures host network functions represented by service graphs.

In an implementation, the method 1500 includes that the service graphs comprise at least one of the following elementary functional blocks: processing components, forwarding components, storage components, and connections.

The method 1500 may be processed in a system 300 for service embedding and resource orchestration, also denoted herein as future carrier network (FCN) architecture as described above with respect to FIG. 3. The method 1500 may be processed in a future carrier network reference scenario 200 as described above with respect to FIG. 2.

From the foregoing, it will be apparent to those skilled in the art that a variety of methods, systems, computer programs on recording media, and the like, are provided.

The present disclosure also supports a computer program product including computer executable code or computer executable instructions that, when executed, causes at least one computer to execute the performing and computing steps described herein.

Many alternatives, modifications, and variations will be apparent to those skilled in the art in light of the above teachings. Of course, those skilled in the art readily recognize that there are numerous applications of the patent application beyond those described herein. While the present patent applications has been described with reference to one or more particular embodiments, those skilled in the art recognize that many changes may be made thereto without departing from the scope of the present patent application. It is therefore to be understood that within the scope of the appended claims and their equivalents, the patent application may be practiced otherwise than as specifically described herein.

What is claimed is:

1. A system for service embedding and resource orchestration, the system comprising:
a service providing entity to provide services to users;
at least one physical infrastructure providing entity, configured to provide infrastructures comprising physical resources which are virtualized and exposed for usage;
a brokering entity interfacing the service providing entity and the at least one physical infrastructure providing entity; and
wherein the brokering entity is configured to provide the service providing entity with the infrastructures from the at least one physical infrastructure providing entity based on an optimization criterion with respect to availability, cost and technical characteristics of the infrastructures.

2. The system of claim 1, wherein the brokering entity comprises a negotiating entity configured to perform one or more of the following:
keep updated information on the at least one physical infrastructure providing entity;
receive service requests from the service providing entity;
negotiate and reserve resources with the at least one physical infrastructure providing entity;
manage offers for the service requests with the service providing entity; and
trigger a Solution Embedding procedure towards negotiating entities of the at least one physical infrastructure providing entity.

3. The system of claim 1, wherein the brokering entity comprises an orchestrating entity configured to perform one or more of the following:
split the service requests into sub graphs in accordance with the optimization criterion, in particular based on a partition assignment generation algorithm; and
determine rearrangement and re-embedding of the service requests based on modified conditions at the at least one physical infrastructure providing entity, in particular based on an optimization and reconfiguration algorithm.

4. The system of claim 1, wherein the brokering entity comprises a resource manager configured to perform one or more of the following:
allow the brokering entity to access the physical resources, and
maintain and manage access information at the brokering entity and at the service providing entity.

5. The system of claim 1, wherein the brokering entity comprises a database configured to:
collect data relating to technical characteristics and pricing information of the at least one physical infrastructure providing entity.

6. The system of claim 2, wherein each of the physical infrastructure providing entities comprises a database configured to collect data relating to the physical resources controlled by the physical infrastructure providing entity.

7. The system of claim 6, wherein each of the at least one physical infrastructure providing entity comprises a negotiating entity configured to perform one or more of the following:
define pricing and publishing criteria for the physical resources relating to the physical infrastructure providing entities;
update and maintain the database of each physical infrastructure providing entity with pricing and publishing information;
manage a publication procedure towards the negotiating entity of the brokering entity; and
manage the negotiation and resource reservation procedure with the negotiating entity of the brokering entity.

8. The system of claim 1, wherein each of the at least one physical infrastructure providing entity comprises an orchestrating entity configured to perform one or more of the following:
embed the service request with respect to technical and pricing characteristics of the physical infrastructure providing entity in accordance with an optimization criterion, in particular based on an embedding algorithm;
negotiate with virtualization controllers of the physical resources with regard to virtualization and exposal of the physical resources;
trigger an instantiation procedure where virtual infrastructure are instantiated over physical infrastructures; and
determine rearrangement and re-embedding of the service requests based on modified conditions at the physical resources, in particular based on an optimization and reconfiguration algorithm.

9. The system of claim 8, wherein each of the at least one physical infrastructure providing entity comprises a resource manager configured to perform one or more of the following:
handle a registration procedure for the physical resources;
perform the instantiation procedure with the orchestration entity of the physical infrastructure providing entity; and
map high level requests from one of the service providing entity and the brokering entity into low level commands specific to physical resources.

10. The system of claim 9, further comprising:
an interface between the brokering entity and the physical resources configured to access information and to monitor data transfer;
an interface between the at least one physical infrastructure providing entity and the physical resources configured to carry signaling and to discover and control the physical resources;
an interface between the at least one physical infrastructure providing entity and the brokering entity configured to carry signaling for the publication procedure, the negotiation and resource reservation procedure, the embedding the service request, the management of access information and the instantiation procedure; and
an interface between the brokering entity and the service providing entity configured to carry signaling required by the service providing entity to issue the service request, to support offer and negotiation procedure between the service providing entity and the brokering entity and to transfer required access information to the service providing entity.

11. A method for service embedding and resource orchestration in a system, the system comprising a service providing entity for providing services to users, a set of physical infrastructure providing entities for providing infrastructures made by physical resources and a brokering entity for providing the service providing entity with the infrastructures from the physical infrastructure providing entities, the method comprising:
publishing the infrastructures and updating databases of the physical infrastructure providing entities and the brokering entity, the databases indicating a status of the physical resources;
negotiating the services between the service providing entity and the brokering entity in order to determine an embedding solution with respect to the set of physical infrastructure providing entities according to an optimization criterion; and
instantiating the set of physical infrastructure providing entities of the determined embedding solution, wherein each physical infrastructure providing entity of the set of physical infrastructure providing entities instantiates a partition of the embedding solution.

12. The method of claim 11, further comprising:
rearranging the partition of the embedding solution by a particular physical infrastructure providing entity of the set of physical infrastructure providing entities based on changes in the physical resources managed by the particular physical infrastructure providing entity.

13. The method of claim 11, further comprising:
rearranging the partition of the embedding solution by the brokering entity based on triggering conditions.

14. The method of claim 11, wherein the embedding solution comprises virtualized network infrastructures host network functions represented by service graphs.

15. The method of claim 14, wherein the service graphs comprise at least one of the following elementary functional blocks:
processing components;
forwarding components;
storage components; and
connections.

16. The method of claim 11, wherein the brokering entity comprises an orchestrating entity, and the method further comprises:
splitting the service requests into sub graphs in accordance with the optimization criterion, in particular based on a partition assignment generation algorithm; and
determining rearrangement and re-embedding of the service requests based on modified conditions at the physical infrastructure providing entities, in particular based on an optimization and reconfiguration algorithm.

17. The method of claim 11, wherein the brokering entity comprises a resource manager, and the method further comprises:
allowing the brokering entity to access the physical resources; and
maintaining and managing access information at the brokering entity and at the service providing entity.

18. The system of claim 2, wherein the brokering entity comprises a database, and the method further comprises:
collecting data relating to technical characteristics and pricing information of the available physical infrastructure providing entities.

19. The method of claim 12, comprising:
rearranging the partition of the embedding solution by the brokering entity based on triggering conditions.

20. The method of claim 12, wherein the embedding solution comprises virtualized network infrastructures host network functions represented by service graphs.
